(19) United States
(12) Patent Application Publication
(10) Pub. No.: US 2026/0332678 A1
(43) Pub. Date: Oct. 22, 2026

(54) APPARATUSES AND METHODS FOR FACILITATING A NAVIGATOR OF COMMUNICATION NETWORK AND SYSTEM APPLICATIONS, COMPONENTS, DEVICES, AND FUNCTIONS AS PART OF ONE OR MORE PLATFORMS

(71) Applicant: AT&T Intellectual Property I, L.P., Atlanta, GA (US)

(72) Inventor: Seyed Hashemi, Johns Creek, GA (US)

(73) Assignee: AT&T Intellectual Property I, L.P., Atlanta, GA (US)

(21) Appl. No.: 19/184,038

(22) Filed: Apr. 21, 2025

(51) Int. Cl. H04L 67/51; H04B 1/00; H04W 48/16

(52) U.S. Cl. CPC H04L 67/51; H04B 1/0003; H04W 48/16

(57) ABSTRACT

Aspects of the subject disclosure may include, for example, identifying a network, resulting in a first identification, identifying a platform, resulting in a second identification, then integrating, based on the first identification and the second identification, at least a portion of the network as part of the platform in conjunction with information models, and presenting, based on the information models, a visualization of a service path topology of the at least a portion of network services within an environment of the platform as part of a radio access network intelligent controller application (rAPP). Other embodiments are disclosed.

### FIELD OF THE DISCLOSURE

The subject disclosure relates to apparatuses and methods for facilitating a system navigator of communication network and system applications, components, devices, and functions as part of one or more platforms.

### BACKGROUND

Vast communication networks and systems, and various communication devices, are utilized in provisioning communication services and sessions. It can be difficult for network/system operators and service providers to fully understand and comprehend the interdependencies between the various applications, components, devices, and functions of the network/system in relation to qualities or characteristics of the communication services/sessions. For example, while some operators/vendors offer techniques for visualizing cloud infrastructure and its accompanying virtualization layer, there is no comprehensive, end-to-end service path view of the network service/system that is conventionally attainable.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A and 2B are block diagrams illustrating example, non-limiting embodiments of systems in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating a system navigator of communication network and system applications, components, devices, and functions, potentially within a purview/domain of one or more platforms or architectures. Other embodiments are described in the subject disclosure.

One or more aspects of the subject disclosure include, in whole or in part, identifying a network, resulting in a first identification; identifying a platform, resulting in a second identification; integrating, based on the first identification and the second identification, at least a portion of the network as part of the platform; and presenting, based on the integrating, a topology of the at least a portion of the network within an environment of the platform.

One or more aspects of the subject disclosure include, in whole or in part, integrating data, a function, a network device, and a first application of a communication network as part of a second application; and integrating the second application as part of an intelligent automation platform to facilitate a management of a plurality of communication services.

One or more aspects of the subject disclosure include, in whole or in part, integrating, by a processing system including a processor, data of a network as part of a container; instantiating, by the processing system and based on the integrating, the container as part of a cloud computing platform; and operating upon, by the processing system, the data in conjunction with the container instantiated as part of the cloud computing platform to effectuate a modification in a configuration of the network from a first configuration to a second configuration that is different from the first configuration.

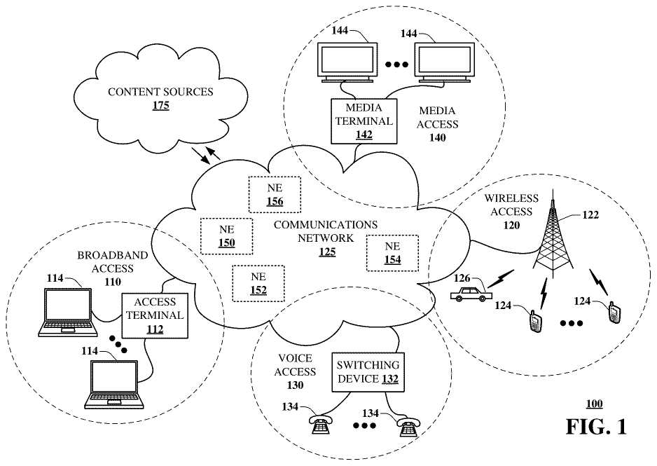

Referring now to FIG. 1, a block diagram is shown illustrating an example, non-limiting embodiment of a system 100 in accordance with various aspects described herein. For example, the system 100 can facilitate, in whole or in part, identifying a network, resulting in a first identification, identifying a platform, resulting in a second identification, integrating, based on the first identification and the second identification, at least a portion of the network as part of the platform, and presenting, based on the integrating, a service path topology of the at least a portion of the network within an environment of the platform. The system 100 can facilitate, in whole or in part, integrating data, a function, a network device, and a first application of a communication network as part of a second application, and integrating the second application as part of an intelligent automation platform to facilitate a management of a plurality of communication services. The system 100 can facilitate, in whole or in part, integrating, by a processing system including a processor, data of a network as part of a container, instantiating, by the processing system and based on the integrating, the container as part of a cloud computing platform, and operating upon, by the processing system, the data in conjunction with the container instantiated as part of the cloud computing platform to effectuate a modification in a configuration of the network from a first configuration to a second configuration that is different from the first configuration.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, and as one of skill in the art will appreciate, U.S. Pat. No. 11,997,583 (the contents of which are incorporated herein by way of reference) describes an approach of how to discover/identify containerized network functions via a Kubernetes virtualization layer for each containerized network/system function, where such a function may combine aspects of, or be incorporated as part of, physical and software infrastructure. In particular, the disclosure of U.S. Pat. No. 11,997,583 sets forth techniques to enable data collection and processing in relation to such tasks. U.S. Patent Application Publication No. 2023/0396515 (the contents of which are incorporated herein by way of reference) describes techniques for facilitating network repository integration and additional data collection to enable a visualization of a 5G standalone core network solution for a next-generation networking technology (e.g., a Fifth Generation (5G) networking technology) incorporating legacy radio access network (RAN) technologies and cloud RAN solutions.

In accordance with aspects of this disclosure, an application (which may be referred to herein as a network system navigator) may provide a solution or service path topology (which may incorporate hardware, software, firmware, or any combination thereof) that may be disaggregated from one or more existing solutions/topologies, and then refactored into a containerized solution with plugin capabilities to integrate with one or more platforms (e.g., an intelligent automation platform, an operations and maintenance center platform, etc.).

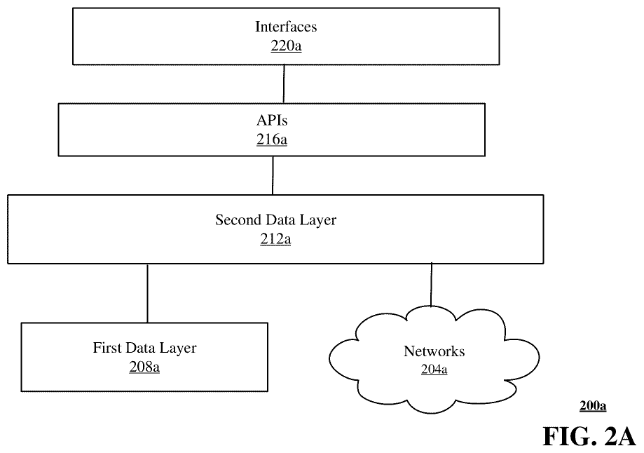

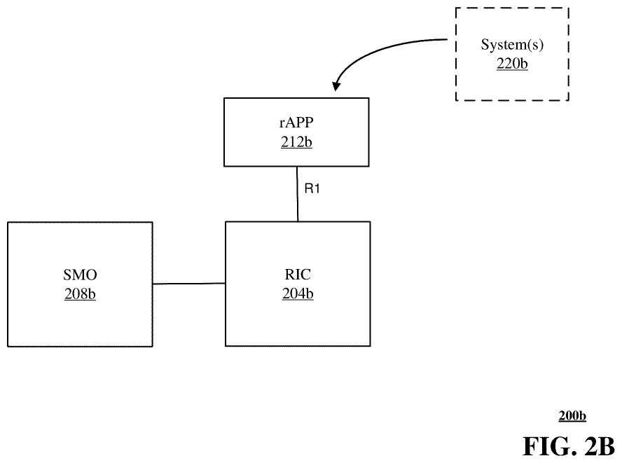

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1. The system 200a may include one or more networks 204a, a first data layer 208a, a second data layer 212a, one or more application programming interfaces (APIs) 216a, and one or more interfaces 220a.

The networks 204a may include a radio access network (RAN), a transport network, and/or a core network. As one of skill in the art will appreciate, the RAN may refer to the part of the network that connects individual devices to the wider network infrastructure using, e.g., radio waves, essentially acting as a bridge between user equipment and the core network through base stations, radio links, and the like. The transport network may correspond to, or include, the underlying infrastructure that carries information or data between different end points of the network, effectively serving as the pipeline for conveying the information/data (as one or more signals) from a source to one or more destinations. The core network may serve as a control point, managing traffic routing, user authentication, authorization, subscriber management data, and ensuring seamless connectivity across different parts of the network.

The first data layer 208a may illustratively include data associated with a database of record (DBOR). The DBOR may correspond to a centralized repository or authoritative source of data within the system 200a. The DBOR may help to ensure consistency and accuracy across various applications and processes. In the context of this disclosure, the DBOR may be used to manage and integrate data from different components and devices.

The second data layer 212a may correspond to, or include, a federated data layer. The federated data layer may be responsible for organizing and generalizing data (such as data associated with the first data layer 208a) to support information base model integration. In this respect, the second data layer 212a may support various functions, such as data cataloging, data transformation/processing, mapping constructs for purposes of interpreting data (e.g., raw data or processed data) within the context of the network, etc. In some embodiments, the second data layer 212a may utilize machine learning (ML) and/or artificial intelligence (AI) to facilitate predictive and proactive capabilities regarding trends or patterns in the data, likely spots or locations of potential issues, etc.

The APIs 216a may correspond to, or include, a set of rules that may allow programs or applications to communicate with one another. For example, the APIs 216a may be used to connect functions within the network or between the network and external applications (not shown in FIG. 2A). The APIs 216a may support/enable operators to virtualize parts of the network and provide tailored data/feature sets to developers, maintenance/management personnel, and the like. In the context of FIG. 2A, the APIs 216a may be used to interface the second data layer 212a and the interface(s) 220a.

The interface(s) 220a may include one or more graphical user interfaces (GUIs). The UIs may enable a network operator (or, analogously, a user) to visualize how various entities (e.g., components, devices, and applications) of the network are arranged, the interdependencies that may be present between the entities, etc. In the context of troubleshooting, the relationships between the various entities may be used to pinpoint or identify a root cause of a network service issue. In some embodiments, a user may have an ability to obtain data associated with a given entity, for example by selecting the entity within the interface(s) 220a.

As one of skill in the art will appreciate based on a review of this disclosure, the system 200a may represent a dramatically simplified view of an actual network in practice. Indeed, many modern networks support hundreds or thousands of nodes, applications, signaling service paths, etc., each of which may need to be carefully managed and orchestrated to ensure seamless integration and continuous operability/functionality. Moreover, a network is rarely (if ever) static in nature. For example, user mobility is representative of one of a multitude of dynamic/variable parameters that may impact/influence network/system operations. In this respect, and with reference to the system 200b shown in FIG. 2B, a radio intelligent controller (RIC) 204b may be utilized to support an allocation of RAN resources for facilitating practical applications involving communication services or sessions. The RIC 204b may provide analytics/processing functions/capabilities to generate recommendations for resource allocations (and any modifications thereto). In some embodiments, the RIC 204b may be implemented as a cloud native solution and may correspond to a component of an open and/or virtualized RAN network.

The RIC 204b may include, or support, a number of functions. For example, the RIC 204b may be responsible for facilitating service management and exposure functions, supporting AI or ML workflow functions, terminating different points of a network, etc.

The RIC 204b may be included as part of, or may interface to, a service management orchestrator (SMO) 208b. The SMO 208b may be responsible for centrally managing and automating the provisioning and configuring of network services across one or more domains.

As part of one or more platforms or architectures of this disclosure (e.g., in conjunction with an O-RAN architecture), a RAN intelligent controller application (rAPP) 212b may be used as a program to run/execute on, or interface to (via, e.g., a R1 interface), the RIC 204b to perform network management and optimization tasks. In this manner, intelligent automation of a RAN may be realized by providing a pathway for applications (e.g., external applications) to access and manipulate network data and functions within the RIC 204b. The R1 interface may act/function as a communication channel between the rAPP 212b and the RIC 204b, thereby facilitating an exchange of information and enabling an execution of actions, potentially without needing to directly interact with the underlying RAN hardware. Functionalities associated with one or more systems 220b (where the system(s) 220b may include one or more portions of the system 200a of FIG. 2A in one or more embodiments) may be integrated as part of the rAPP 212b.

Aspects of the systems 200a and 200b may support a number of functions. For example, aspects of the systems 200a and 200b may support a number of networking functions, such as an authentication server function (AUSF), an access and mobility management function (AMF), an application function (AF), a charging function (CHF), a data network, operator services, and Internet access function (DN), a network exposure function (NEF), a network repository function (NRF), a network slice selection function (NSSF), a network data analytics function (NWDAF), a network slice specific authentication and authorization function (NSSAAF), a policy control function (PCF), a communication proxy function (SCP), a security edge protection function (SEPP), a session management function (SMF), a user plane function (UPF), a location management function LMF), etc. Additionally, support may be provided for cloud management functions (which may be referred to herein more generally as operations and maintenance center (OMC) functions). A containerized approach to the functions may be included/supported, and by virtue of integration of the systems and functions as part of the rAPP 212b as described above, data may be operated upon natively (e.g., may be operated on within the constructs or environment of a target or associated platform).

Aspects of this disclosure may effectively help to remove barriers that exist in the conventional state of the art. Containerized services and applications may be seamlessly integrated as part of one or more platforms or architectures, enabling network data to be used as part of such platforms/architectures natively. The use of such data may facilitate end-to-end visualization of a network, encapsulated within the purview/framework of a given target platform or architecture. This may be contrasted with the current state of the art, where network engineers/operators frequently navigate a complex matrix or graph of network/system components, devices, applications, and functions, in an effort to pinpoint or identify/determine where potential issues may exist (or for other purposes, such as monitoring the performance of behavior of a network). Thus, aspects of this disclosure represent substantial improvements to technology in respect of practical applications involving a provisioning of communication services or sessions.

Referring now to FIG. 2C, an illustrative embodiment of a method 200c in accordance with various aspects described herein. The method 200c may be implemented or executed, in whole or in part, in conjunction with one or more systems, devices, and/or components, such as for example the systems, devices, and components set forth herein. In some embodiments, the method 200c may be wholly or partially implemented or executed via one or more processing systems, where each such processing system may include one or more processors. Further, in some embodiments, operations of the method 200c may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200c are described below in relation to the blocks shown in FIG. 2C. In some embodiments, one or more blocks or operations may be based on one or more other blocks or operations.

In block 204c, one or more networks may be identified. For example, the identification of the networks may be based on a geographical location, a logical location (that may potentially span diverse/different geographical locations), a function that is performed or supported, a technology type/kind that is supported, etc. In this respect, aspects of block 204c may follow a parameterized approach towards focusing or isolating on one or more parts/portions of a larger/broader network.

In block 208c, a target platform may be identified. For example, the target platform may be associated with one or more operators or vendors that may be different from an operator or sponsor of the network(s) identified as part of block 204c.

In block 212c, the identified network(s) (of block 212c) may be integrated as part of the target platform (of block 208c). In the context of block 212c, integration may include casting or refactoring one or more data/information models of the network(s) to conform to constructs associated with the target platform. In some embodiments, the integration may correspond to, or include, a use of an rAPP (as depicted in FIG. 2B, for example). By virtue of the integration of block 212c, the data/information associated with the network may be operated upon natively within the target platform environment.

In block 216c, one or more outputs may be generated. For example, as part of block 216c, a presentation or visualization of the identified network(s) (of block 204c) may be obtained (such as, for example, in relation to a user interface that may be supported by the target platform of block 208c). The outputs of block 216c may include one or more messages or reports that may pertain to a performance of the network(s) (or one or more portions thereof). The outputs of block 216c may facilitate interactions with users (e.g., engineers or operators). For example, such interactions may enable the users to suggest modifications to the network(s) and obtaining an assessment of changes in performance based on the modifications.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the realm of modern telecommunications (and other communication services), the rapid evolution of network technologies has introduced a complex array of network applications, components, devices, and functions. These networks are characterized by their intricate architectures, which include a multitude of network functions such as the AMF, SMF, and UPF, among others. As one of skill in the art will appreciate, challenges may exist in effectively managing and visualizing network components, applications, devices, and functions to ensure seamless operation and optimization of network resources. As networks continue to grow in complexity, the need for comprehensive tools that provide an end-to-end view of network topology and performance becomes increasingly important. Aspects of this disclosure address these and other challenges/concerns.

Conventional techniques/technologies fail to deliver a comprehensive, end-to-end view of a communication network or system. Furthermore, a reliance on disparate tools and platforms not only increases operational costs but also adds complexity to network management, as continuous data integration from multiple sources is necessary. In contrast, aspects of this disclosure integrate data from multiple sources within the purview of a common platform or architecture, enabling the data to be operated upon natively and within the environment of the platform/architecture. This may tend to reduce complexity as well as reduce the likelihood of generating inconsistent data or results. In brief, aspects of this disclosure help to facilitate enhancements in efficiencies of operations pertaining to networks and systems, which directly translates into cost-savings for network/system operators and service providers.

Aspects of this disclosure provide a unique approach to network visualization and management. This approach utilizes a refactoring of existing network management solutions into a cloud-native, containerized software application (e.g., an rAPP), which is designed/configured to integrate seamlessly with one or more platforms or architectures. This integration enables a unified view of the RAN, transport, and central/core network components, providing network operators with advanced visualization and navigation capabilities. By leveraging data layers and interfaces associated with a platform, the solutions of this disclosure facilitate deep network discovery and real-time visualization of network configurations (and any modifications thereto), thereby enhancing operational efficiencies and reducing costs. This innovative approach not only fills the existing gaps in network management but also offers significant value to other network service providers by streamlining their operations and improving performance.

As demonstrated herein, the various aspects of this disclosure are not directed to abstract ideas. To the contrary, and as one of skill in the art will appreciate, the various aspects of this disclosure are directed to, and encompass, significantly more than any abstract idea standing alone. Indeed, aspects of this disclosure are directed to substantial improvements to various technologies, including technologies associated with practical applications involving a provisioning of communication services and sessions. The various aspects of this disclosure facilitate a generation of useful, concrete, tangible, and transformative results in respect of such technologies and applications.

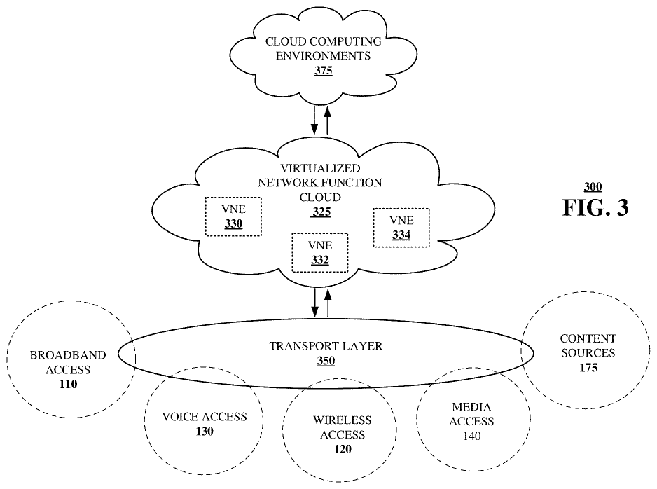

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, system 200b, and method 200c presented in FIGS. 1, 2A, 2B, and 2C. For example, the virtualized communication network 300 can facilitate, in whole or in part, identifying a network, resulting in a first identification, identifying a platform, resulting in a second identification, integrating, based on the first identification and the second identification, at least a portion of the network as part of the platform, and presenting, based on the integrating, a topology of the at least a portion of the network within an environment of the platform. The virtualized communication network 300 can facilitate, in whole or in part, integrating data, a function, a network device, and a first application of a communication network as part of a second application, and integrating the second application as part of an intelligent automation platform to facilitate a management of a plurality of communication services. The virtualized communication network 300 can facilitate, in whole or in part, integrating, by a processing system including a processor, data of a network as part of a container, instantiating, by the processing system and based on the integrating, the container as part of a cloud computing platform, and operating upon, by the processing system, the data in conjunction with the container instantiated as part of the cloud computing platform to effectuate a modification in a configuration of the network from a first configuration to a second configuration that is different from the first configuration.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

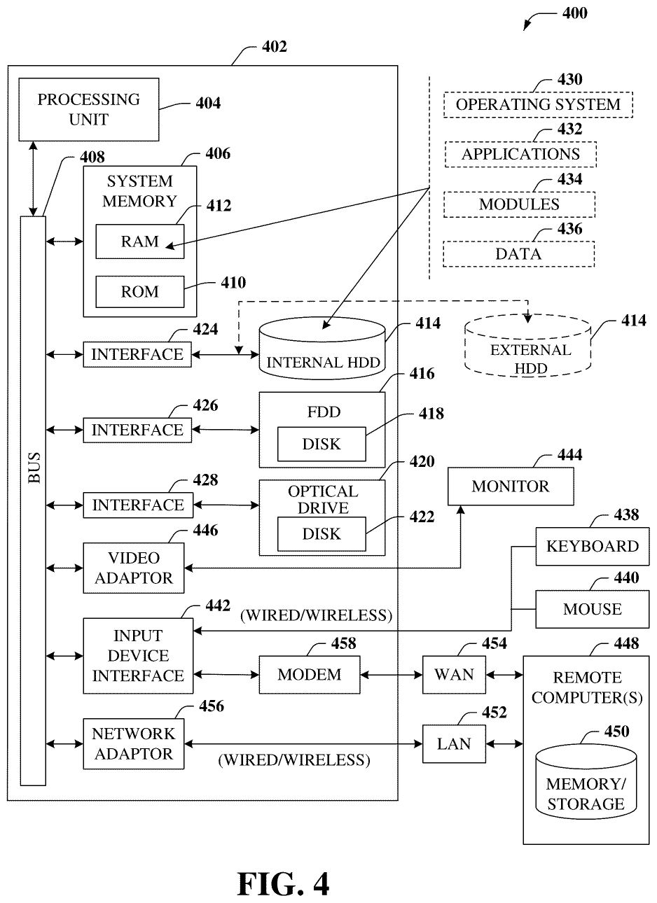

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, identifying a network, resulting in a first identification, identifying a platform, resulting in a second identification, integrating, based on the first identification and the second identification, at least a portion of the network as part of the platform, and presenting, based on the integrating, a topology of the at least a portion of the network within an environment of the platform. The computing environment 400 can facilitate, in whole or in part, integrating data, a function, a network device, and a first application of a communication network as part of a second application, and integrating the second application as part of an intelligent automation platform to facilitate a management of a plurality of communication services. The computing environment 400 can facilitate, in whole or in part, integrating, by a processing system including a processor, data of a network as part of a container, instantiating, by the processing system and based on the integrating, the container as part of a cloud computing platform, and operating upon, by the processing system, the data in conjunction with the container instantiated as part of the cloud computing platform to effectuate a modification in a configuration of the network from a first configuration to a second configuration that is different from the first configuration.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

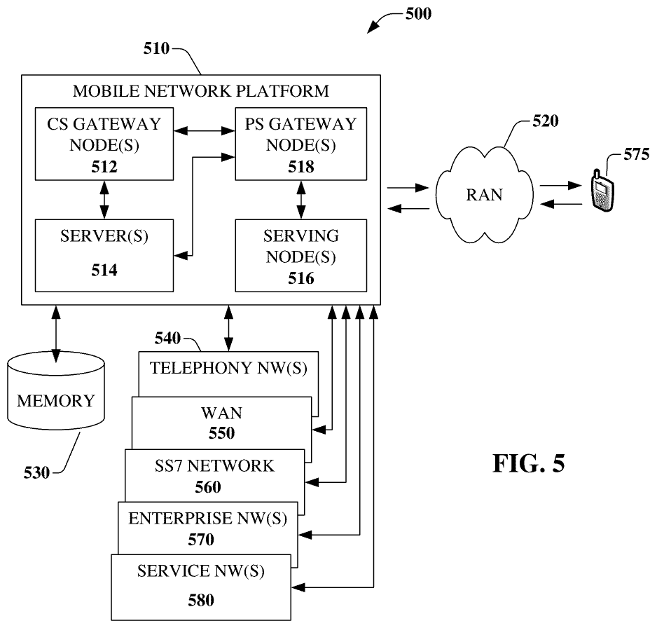

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, identifying a network, resulting in a first identification, identifying a platform, resulting in a second identification, integrating, based on the first identification and the second identification, at least a portion of the network as part of the platform, and presenting, based on the integrating, a topology of the at least a portion of the network within an environment of the platform. The platform 510 can facilitate, in whole or in part, integrating data, a function, a network device, and a first application of a communication network as part of a second application, and integrating the second application as part of an intelligent automation platform to facilitate a management of a plurality of communication services. The platform 510 can facilitate, in whole or in part, integrating, by a processing system including a processor, data of a network as part of a container, instantiating, by the processing system and based on the integrating, the container as part of a cloud computing platform, and operating upon, by the processing system, the data in conjunction with the container instantiated as part of the cloud computing platform to effectuate a modification in a configuration of the network from a first configuration to a second configuration that is different from the first configuration.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

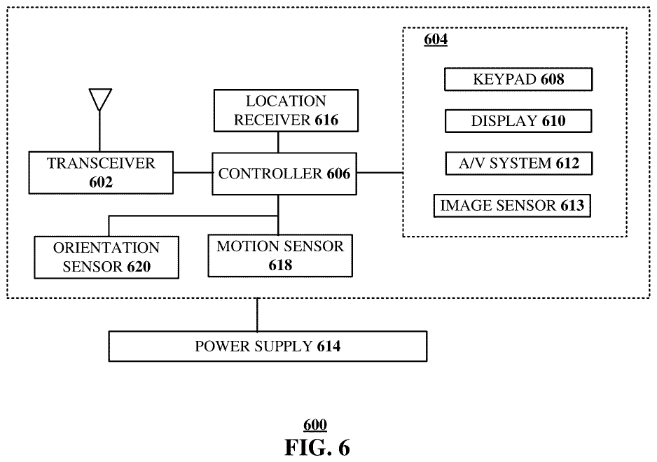

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, identifying a network, resulting in a first identification, identifying a platform, resulting in a second identification, integrating, based on the first identification and the second identification, at least a portion of the network as part of the platform, and presenting, based on the integrating, a topology of the at least a portion of the network within an environment of the platform. The computing device 600 can facilitate, in whole or in part, integrating data, a function, a network device, and a first application of a communication network as part of a second application, and integrating the second application as part of an intelligent automation platform to facilitate a management of a plurality of communication services. The computing device 600 can facilitate, in whole or in part, integrating, by a processing system including a processor, data of a network as part of a container, instantiating, by the processing system and based on the integrating, the container as part of a cloud computing platform, and operating upon, by the processing system, the data in conjunction with the container instantiated as part of the cloud computing platform to effectuate a modification in a configuration of the network from a first configuration to a second configuration that is different from the first configuration.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth^{®}. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
identifying a network, resulting in a first identification;
identifying a platform, resulting in a second identification;
integrating, based on the first identification and the second identification, at least a portion of the network as part of the platform; and
presenting, based on the integrating, a topology of the at least a portion of the network within an environment of the platform.

2. The device of claim 1, wherein the integrating comprises integrating data of the network as part of the platform.

3. The device of claim 1, wherein the integrating comprises integrating an application executed by the network as part of the platform.

4. The device of claim 1, wherein the integrating comprises integrating a network device of the network as part of the platform.

5. The device of claim 1, wherein the integrating comprises integrating a network function of the network as part of the platform.

6. The device of claim 1, wherein the operations further comprise:
containerizing a plurality of services supported by the network,
wherein the integrating is based on the containerizing.

7. The device of claim 1, wherein the at least a portion of the network includes a radio access network of the network.

8. The device of claim 1, wherein the at least a portion of the network includes a transport network of the network.

9. The device of claim 1, wherein the at least a portion of the network includes a core network of the network.

10. The device of claim 1, wherein the presenting is based on a use of a user interface of the platform.

11. The device of claim 10, wherein the operations further comprise:
obtaining, via the user interface, a user-generated input that includes a proposed modification to the network.

12. The device of claim 11, wherein the operations further comprise:
providing, via the user interface, an indication of a change in a performance of the network based on the proposed modification.

13. The device of claim 12, wherein the operations further comprise:
determining the change in the performance of the network using machine learning, artificial intelligence, or a combination thereof.

14. A non-transitory machine-readable medium, comprising executable instructions that, when executed by a processing system including a processor, facilitate performance of operations, the operations comprising:
integrating data, a function, a network device, and a first application of a communication network as part of a second application; and
integrating the second application as part of an intelligent automation platform to facilitate a management of a plurality of communication services.

15. The non-transitory machine-readable medium of claim 14, wherein the integrating of the data, the function, the network device, and the first application of the communication network is based on a use of at least one containerized service.

16. The non-transitory machine-readable medium of claim 14, wherein the management of the plurality of communication services occurs via an interface of the intelligent automation platform.

17. The non-transitory machine-readable medium of claim 14, wherein the second application communicates with a radio intelligent controller over an R1 interface.

18. A method, comprising:
integrating, by a processing system including a processor, data of a network as part of a container;
instantiating, by the processing system and based on the integrating, the container as part of a cloud computing platform; and
operating upon, by the processing system, the data in conjunction with the container instantiated as part of the cloud computing platform to effectuate a modification in a configuration of the network from a first configuration to a second configuration that is different from the first configuration.

19. The method of claim 18, wherein at least one of the integrating or the instantiating is based on a use of a radio access network intelligent controller application.

20. The method of claim 18, further comprising:
presenting, by the processing system and based on the instantiating, a topology of the network within an environment of the cloud computing platform.
